(19) United States
(12) Patent Application Publication
(10) Pub. No.: US 2025/0373611 A1
(43) Pub. Date: Dec. 4, 2025

(54) MULTI-DOMAIN, ROLE-BASED ACCESS CONTROL USING LARGE LANGUAGE MODELS

(71) Applicant: American Express Travel Related Services Company, Inc., New York, NY (US)

(72) Inventor: Andras L. Ferenczi, Scottsdale, AZ (US)

(21) Appl. No.: 18/679,574

(22) Filed: May 31, 2024

(51) Int. Cl. H04L 9/40

(52) U.S. Cl. CPC H04L 63/10; H04L 63/0807

(57) ABSTRACT

Disclosed are various embodiments for multi-domain, role-based access control (RBAC) using large language models. Various embodiments can receive an access request from a client device associated with a user. Various embodiments can then send a prompt to identify a user role for the user to an agent of a machine learning model. Various embodiments can receive the user role for the user from the agent. The various embodiments can determine the capability for the user to access a resource by comparing the user role for the user to allowed user roles for the resource. Various embodiments can then send an access response to the client device that indicates whether the user can access the resource.

### BACKGROUND

Role-Based Access Control (RBAC) systems are security models that regulate access to resources based on predefined roles individuals are assigned within an organization or overarching computing system. RBAC systems provide granular access control for users based on pre-defined user roles within an organization. By assigning permissions to roles rather than individual users, access to organizational resources (e.g., files, websites, physical spaces, etc.) can be more easily managed. However, with existing RBAC systems, management of applying roles to specific users can still be burdensome. Often, users who have not been assigned necessary user roles would not be able to access their necessary organizational resources. Additionally, users may have been over-assigned roles and the users may have access to organizational resources that the users should not be permitted to access.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a sequence diagram illustrating one example of functionality implemented as portions of a client application, a resource service, an authentication service, an agent, a base foundation model, a role-based access control (RBAC) service, and an application programming interface (API) executed in the network environment of FIG. 1 according to various embodiments of the present disclosure. The sequence diagram of FIG. 2 illustrates an example where the authentication service can interact with the agent, which is trained to obtain information from the RBAC service and/or an API and determine user roles of a specified user. The user roles determined by the agent can dictate whether the user has access to a specific resource, as served by the resource service.

FIG. 3 is a sequence diagram illustrating one example of functionality implemented as portions of a client application, a resource service, an authentication service, an agent, a base foundation model, a role-based access control service, and an application programming interface executed in the network environment of FIG. 1 according to various embodiments of the present disclosure. The sequence diagram of FIG. 3 illustrates an example where the authentication service can obtain information from the RBAC service and/or an API, then direct an agent determine user roles of a specified user. The user roles determined by the agent can dictate whether the user has access to a specific resource, as served by the resource service.

FIG. 4 is a sequence diagram illustrating one example of functionality implemented as portions of a client application, a resource service, an authentication service, an agent, a base foundation model, a role-based access control service, and an application programming interface executed in the network environment of FIG. 1 according to various embodiments of the present disclosure. The sequence diagram of FIG. 4 illustrates an example where the authentication service can interact with the agent, which is trained to obtain information from the RBAC service and/or an API and determine user roles of a specified user. The user roles determined by the agent can dictate whether the user has access to a specific resource, which the authentication service can deliver.

FIG. 5 is a sequence diagram illustrating one example of functionality implemented as portions of a client application, a resource service, an authentication service, an agent, a base foundation model, a first role-based access control service, and a second role-based access control service executed in the network environment of FIG. 1 according to various embodiments of the present disclosure. The sequence diagram of FIG. 2 illustrates an example where the authentication service can interact with the agent, which is trained to obtain information from the first RBAC service and the second RBAC service, and then determine user roles of a specified user. The user roles determined by the agent can dictate whether the user has access to a specific resource, as served by the resource service.

### DETAILED DESCRIPTION

Disclosed are various approaches for multi-Domain, role-based access control using large language models. Role-based access control (RBAC) systems are security models that regulate access to resources based on predefined roles individuals are assigned within an organization or overarching computing system. RBAC systems can provide granular access control over users based on pre-defined user roles within an organization. By assigning permissions to roles rather than individual users, access to organizational resources (e.g., files, websites, physical spaces, etc.) can be more easily managed.

However, various problems exist with traditional RBAC systems. For example, management of users as they relate to user roles still requires significant manual oversight by technical support specialists or human resource specialists. For instance, a software developer might have access to a large number of resources related to software code, image assets, technical information, non-confidential information, and other non-critical resources. A human resource (HR) manager, by contrast might have access to image assets, non-confidential information, confidential information, and other non-critical resources. A member of the C-Suite (e.g., Chief Executive Officer, Chief Operating Officer, Chief Medical Officer, Chief Financial Officer, etc.), by further contrast, may have full access to all the resources available at an organization. The roles of software developer, HR manager, and C-Suite personnel could be individual roles related to a person's job. Other roles may also exist to identify what physical spaces (e.g., buildings, offices, rooms, etc.) a person may access. For instance, a person may be assigned a role that allows them access to the sixteenth floor of the Atlanta office, whereas another person may be assigned a role to allow them access to the entirety of the New York office. Each of these roles must then be individually assigned to users and manually managed by technical support specialists or human resource specialists. Creating new roles requires the technical support specialists or human resource specialists to assign existing users to that new role. Additionally, adding a new user (e.g., employee, customer, etc.) requires the technical support specialists or human resource specialists to assign that new user one or more roles.

These manual processes can often be overwhelming, especially as the number of users and/or the number of roles scales to larger quantities. When changes occur to users (e.g., promotions, moving to different offices, firing, etc.), the technical support specialists or human resource specialists will have to modify the users' roles so that the user will have access or not have access to certain organizational resources. When organizations include large quantities of users or roles, managing each person can be incredibly taxing due to the manual nature of the traditional RBAC systems.

Various embodiments of the present disclosure solve these problems. Various embodiments integrate a large language model (LLM) to dynamically interpret and analyze relationships to infer and implement RBAC dynamically, ensuring adaptability and intuitive access management. In various embodiments, the user interacts with an authentication service by making requests and the authentication service, in turn, utilizes the LLM to interpret the user's relationships and roles, making real-time decisions on access permissions. This approach is versatile, finding applicability in numerous fields, such as corporate settings, healthcare, and education. This approach can address diverse needs, like risk management and dynamic permission allocation, effectively. Such an approach can emphasize crucial aspects of privacy, scalability, and security. Various embodiments seek to create a robust, flexible, and secure medium to manage access, focusing on the relationships and roles of individuals within diverse organizational frameworks.

Various embodiments can be used in various business use cases. For example, an access manager can indicate that resources (e.g., files, websites, physical spaces, etc.) should have specific permissions to limit who can access the resources. For instance, an access manager can could enter or ask a digital assistant (Siri®, Cortana®, Alexa®, Meta AI, ChatGPT-4 Omni, etc.) to enter permissions for a data folder (e.g., a OneDrive® directory, a shared folder, etc.), such as “only grant access to this data folder to persons who work under John Doe.” Using various data sources (e.g., employee directories, LinkedIn®, other content, etc.), various embodiments can determine whether any one specific user is permitted to access the data folder by using a large language model to extrapolate permission sets from the access manager's prompt. Such a permission system could even permit brand new employees to access the folder, even if such a new employee does not directly work for John Doe, because it could be determined that the new employee indirectly works under John Doe.

Various embodiments can also be used for non-business use cases. For example, a user of a social media platform (e.g., Facebook®, X®, Instagram®, TikTok®, etc.) can set a permission for a resource dynamically. For instance, a user could enter or ask a digital assistant (Siri®, Cortana®, Alexa®, Meta AI, ChatGPT-4 Omni, etc.) to enter permissions for a photo album on Facebook, like “grant access to wedding photo album to my friends who attended the wedding.” When other users are then attempting to access that photo album on Facebook®, various embodiments can utilize large language models that can utilize additional content (e.g., wedding registry, email messages, etc.) to determine whether the specific user meets the permission requirement set by the owner of the photo album. Various embodiments could even determine permission sets that could handle complex relationships, like “my friends of friends,” “my family,” or “people I used to work with,” without explicitly having some data chart explicitly organizing those relationships, but instead referring to publicly or privately available information from various data sources (e.g., Facebook®, X®, LinkedIn®, Outlook®, organizational charts, RBAC, and Active Directory® systems, etc.).

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

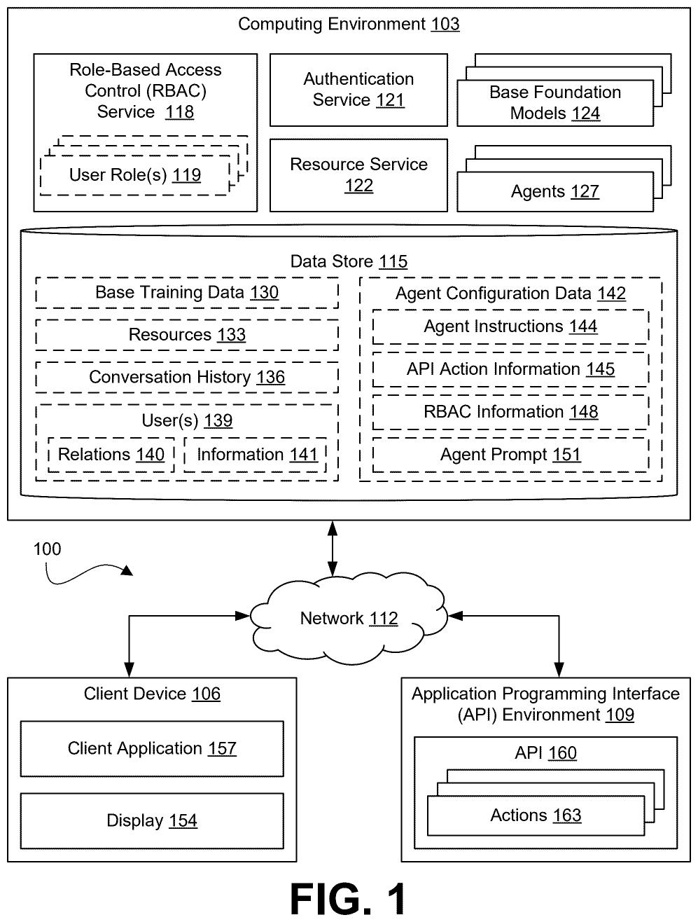

With reference to FIG. 1, shown is a network environment 100 according to various embodiments. The network environment 100 includes a computing environment 103, a client device 106, and Application Programming Interface (API) environment 109, which are in data communication with each other via a network 112. The network 112 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The computing environment 103 can include, for example, a server computer or any other system providing computing capability. Alternatively, the computing environment 103 can employ a plurality of computing devices that can be arranged, for example, in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource and/or any other distributed computing arrangement. In some cases, the computing environment 103 can correspond to an elastic computing resource where the allotted capacity of processing, network, storage, or other computing-related resources can vary over time.

Various applications and/or other functionality can be executed in the computing environment 103 according to various embodiments. Also, various data can be stored in a data store 115 that can be accessible to the computing environment 103. The data store 115 can be representative of a plurality of data stores 115 as can be appreciated. The data stored in the data store 115, for example, can be associated with the operation of the various applications and/or functional entities described below.

The components executed on the computing environment 103, for example, can include an RBAC service 118, an authentication service 121, a resource service 122, one or more base foundation models 124 (generically as “a base foundation model 124”), one or more agents 127 (generically as “an agent 127”), and other applications, services, processes, systems, engines, or functionality not discussed in detail herein.

The term “foundation model” can refer to large neural network-based machine learning (ML) models. A foundation model can be trained initially (also call “pre-trained”) using enormous amounts of data, such as the base training data 130. The resulting pre-trained foundation model can be a base foundation model 124 that can learn enough about the input to be relatively easily adapted for many different downstream tasks. The base foundation model 124 can also be referred to as a pre-trained foundation model, a baseline foundation model, or a core foundation model to distinguish them from fine-tuned or configured instances of foundation models, also referred to as agents 127. In some embodiments, a base foundation model 124 can be fine-tuned one or more times. In some embodiments, a base foundation model 124 can further be configured to execute to a specified computing device or computing devices, such as the computing environment 103.

The base foundation models 124 can be referred to as “large” because of the number of parameters that they each comprise (e.g., billions or more parameters). The base foundation models 124 can be referred to as “foundation” models in a sense that they can provide a foundation for performing many different kinds of inference or prediction tasks. Some base foundation models 124 can be large language models (LLMs) and/or small language models (SLMs), which can be pre-trained using natural language inputs, are a type of foundation model that can be used for a variety of applications including summarization, question-answering chatbots, classification and the like. An example of a base foundation model 124 can include a Generative Pre-trained Transformer (GPT) (e.g., GPT-3, GPT-4, etc.), Bidirectional Encoder Representations from Transformers (BERT), or other language models.

Pre-training of foundation models may often use unsupervised, self-supervised or semi-supervised training techniques. A base foundation model 124 may be fine-tuned (e.g., using a relatively small amount of labeled examples) or configured for specific use cases and specific problem domains, although the base foundation model 124 can itself be able to perform high-quality inference tasks in many cases. In some embodiments, a base foundation model 124 can be fine-tuned or otherwise configured to become an agent 127. In some embodiments, a base foundation model 124 and an agent 127 can be otherwise identical. In some embodiments, base foundation models 124 and agents 127 can differ only in that the agent 127 is more finely-tuned to effectuate a specific business purpose when compared to a corresponding base foundation model 124. In some embodiments, a base foundation model 124 can be trained using various prompts to configure an agent 127. A base foundation model 124 can be configured using the agent configuration data 142 to generate an agent 127. By doing this, the agent 127 can be more narrowly tailored to perform specific functions. For example, a trained agent 127 can access one or more APIs 160, access one or more RBAC services 118 (either on the computing environment 103 or otherwise connected via the network 112), access one or more resources 133 (directly with the data store 115 or via the resource service 122), or various other tasks. A trained agent 127 can also determine whether a specified user should have access to a specified resource 133.

The RBAC service 118 can be a service that has been configured to regulate access to resources based on predefined user roles 119 individuals are assigned within an organization or overarching computing system. In various embodiments of this disclosure, the RBAC service 118 has been simplified to a service that manages and describes one or more user roles 119.

A user role 119 can define a set of permissions that are logically grouped together based on the responsibilities of the users 139 within an organization. For instance, a software developer might have access to a large number of resources related to software code, image assets, technical information, non-confidential information, and other non-critical resources; a human resource (HR) manager, by contrast might have access to image assets, non-confidential information, confidential information, and other non-critical resources; and a member of the C-Suite (e.g., Chief Executive Officer, Chief Operating Officer, Chief Medical Officer, Chief Financial Officer, etc.), by further contrast, may have full access to all the resources available at an organization. The roles of software developer, HR manager, and C-Suite personnel could be individual roles related to a person's job. Other roles may also exist to identify what physical spaces (e.g., buildings, offices, rooms, etc.) a person may access. For instance, a user 139 may be assigned a role that allows them access to the sixteenth floor of the Atlanta office, whereas another user 139 may be assigned a role to allow them access to the entirety of the New York office. Various other types of user roles 119 can also exist. Permissions, for which user roles 119 control, can include various types of values. For example, at least some permissions defined by the user role 119 can be permissions to read, write, execute, and/or delete particular files or folders. At least another permission defined by the user role 119 could be a Boolean value representing allowed or denied accessibility to the resource 133. The user roles 119 can also include a description of what types of users 139 meet the criteria to qualify for the user role 119.

The authentication service 121 can be executed to facilitate the determination of whether a user 139 can access a resource 133. In some embodiments, the authentication service 121 can coordinate communications between a user 139 at the client device 106, an agent 127, an API environment 109, an RBAC service 118, a resource service 122, and information stored in the data store 115, such as resources 133, user relations 140, user information 141, and conversation histories 136. For example, the authentication service 121 can receive an access request (e.g., a request to access a specified resource 133 for by a user 139, etc.) from a client device 106. The authentication service 121 can validate the access request. In at least some embodiments, the authentication service 121 can obtain one or more user roles from an RBAC service 118 and/or obtain additional information from an external system, such as an API 160 or an external RBAC service (not depicted). The authentication service 121 can then generate and send a prompt to the agent 127. The generated prompt can include various types of information, such as one or more user roles 119 received from an RBAC service 118, one or more resources 133 received from the data store 115 or a resource service 122, additional information received from an API 160, a conversation history 136, information about a user 139, such as user relations 140 and user information 141, and/or agent configuration data 142.

For each prompt to and response from the agent 127 or otherwise, the authentication service 121 can “log” or “commit to a trace” any action or response to the conversation history 136, such that the user 139 at the client device 106 or an agent 127 can have context of the entire interaction. The trace or log can help a client follow the reasoning process of the agent 127 that leads the agent 127 to the response it gives at that point in the conversation.

In some embodiments, the agent 127 can provide a response indicating one or more user roles 119 that the agent 127 believes applies to the user 139. In some embodiments, the agent 127 could provide a response indicating that the user 139 did not meet the criteria for any of the user roles 119. Using the inferred user roles 119 from the agent 127, the authentication service 121 can determine whether the specific user 139 at the client device 106 can access to a specific resource 133. In at least one embodiment, the authentication service 121 can determine whether a user 139 can access a resource 133 by comparing the user roles 119 from the agent 127 to the allowed user roles 119 assigned to the resource 133. If at least one of the user roles 119 from the agent 127 matches the allowed user roles 119 assigned to the resource 133, then the authentication service 121 can grant the user 139 at the client device 106 access to the resource 133. If none of the user roles 119 from the agent 127 match the allowed user roles 119 assigned to the resource 133, then the authentication service 121 can deny the user 139 at the client device 106 access to the resource 133. In at least some embodiments, the authentication service 121 can send an access response to the client application 157 at the client device 106 indicating whether the access was granted.

In some embodiments, the authentication service 121 can serve the resource 133 to the client application 157 at the client device 106 in response to determining that the user 139 can access the resource 133. In some embodiments, the authentication service 121 can send a resource request to the resource service 122. The resource request can include an identification of the resource 133 requested. In response, the resource service 122 can provide a resource response, which can include the resource 133 and/or a notification regarding the accessibility of the resource 133 (e.g., denied access to the resource, etc.).

In various embodiments, the access request can include or can be embodied as a JSON Web Token (JWT or JWT token). A JWT token is a data structure that defines a compact and self-contained way for securely transmitting information between parties as a JSON object that can be verified and trusted because it is digitally signed. A JWT token comprises at least three portions, the header, the payload, and the signature. The header typically includes the type of token, which is “JWT,” and the signing algorithm being used. The payload contains the information about the entity (e.g., user 139, etc.) and/or additional data. In various embodiments, the payload can contain an identifier for a specific resource 133 to be accessed, identification for the user 139, and/or any other information. The signature can be cryptographically generated to verify that the header and payload have not been modified. In various embodiments, the authentication service 121 can validate the JWT tokens. In some embodiments, the authentication service 121 can validate the JWT tokens in response to receiving the access request. In at least some embodiments, the authentication service 121 can grant or deny access to a resource 133 by authorizing a portion of the JWT. In various embodiments, the access response can include the JWT.

The resource service 122 can be executed to serve one or more resources 133. The resource service 122 can receive a resource request. The resource request can include an identifier for one or more resources 133. The resource service 122 can validate the resource request to ensure that the receiver (e.g., the user 139, etc.) has permission to access the resource 133. If the resource request is valid and the receiver is permitted to access the resource 133, then the resource service 122 can send a resource response that includes the requested one or more resources 133.

In some embodiments, a JWT token can be used to verify the identity of the user 139. For instance, the resource service 122 can receive a resource request that includes a JWT token. The resource service 122 can validate that the JWT token indicates that the user 139 has been granted access or has been denied access to the resource 133. Alternatively, the resource service 122 can verify that the JWT token indicates that the user 139 has been identified as being within a specified user role 119 to access the resource 133. If the JWT token is valid and the user 139 is permitted to access the resource 133, then the resource service 122 can send the receiver the resource 133.

The data stored in the data store 115 can include, for example, base training data 130, resources 133, conversation histories 136, users 139, agent configuration data 142, and potentially other data. The base training data 130 can represent data sources or data corpuses to train a base foundation model 124. In at least some embodiments, the base training data 130 can represent a substantially large number of text tokens used to train a base foundation model 124. In some embodiments, base training data 130 can also include some base prompts that can assist the agent 127 become better prepared to act as an agent. For instance, the base training data 130 can include information about how to greet people when first initiating a conversation, information about banned language or banned topics, information about ensuring digital security over the internet (e.g., not sharing passwords, and information about not disclosing confidential information, etc.). The information of the base training data 130 can be used as a way to make configuring the base foundation models 124 to an agent 127 more streamlined. Additional information can be stored in the base training data 130.

The resources 133 can represent one or more physical or digital items which a user 139 wishes to access. In some embodiments, a resource 133 represent a physical item (e.g., physical document, a physical space, etc.), which is being protected by some form of access control (e.g., lock and key, key code, etc.). In some embodiments, the resource 133 can represent physical spaces (e.g., buildings, offices, rooms, etc.) a person may access. However, in some embodiments a resource 133 can be a digital asset, such as data files, digital documents, etc. A resource 133 can be associated with one or more user roles 119 that are used to verify whether a person has access to perform an action (e.g., read, write, execute, delete, access, etc.) on the resource 133. When a user 139 is determined to match a user role 119 assigned to the resource 133, the user 139 can access the resource 133.

The conversation history 136 can represent a detailed log of interactions between a client device 106 and an agent 127. For instance, when a client device 106 sends the access request to the authentication service 121, the authentication service 121 can log the access request in the conversation history 136. The authentication service 121 can also log into the conversation history 136 that the authentication service 121 has sent the prompt to an agent 127. The authentication service 121 can also log any response from the agents 127 within the conversation history 136. The conversation history 136 can also be used to display a user-friendly conversation to the client device 106. In such situations, portions of the conversation history 136 can be redacted to make reviewing the information more user-friendly. The conversation history 136 can be used by an agent 127 to identify information to perform activities (e.g., invoking an API 160, accessing a database or a service, etc.).

The users 139 can represent an account or a digital representation of a person associated with a software application and/or the computing environment 103. The users 139 can be associated with one or more client devices 106, which the person for which the user 139 represents can access the software application and/or the computing environment 103 via the client application 157. In various embodiments, a user 139 can interact with an authentication service 121 and a resource service 122. In many embodiments, the user 139 can attempt to access one or more resources 133. However, the user 139 must first be associated with the necessary user roles 119 to access a specified resource 133. Accordingly, the user 139 can be assigned one or more user roles 119 by the authentication service 121. Users 139 can be assigned user roles 119 for various logical groupings, such as position in an organization (e.g., manager, C-Suite executive, human resources, technical support, etc.), their physical location (e.g., office, building, floor, access to rooms, etc.), or other logical groupings.

The user 139 can include user relations 140. In some embodiments, a user 139 may just be added and at least one piece of information used to identify a user's role is their relations 140 with other users 139. For instance, a new user 139 can be added to the data store 115 who is initially setup to be the subordinate of a manager user 139. The manager user 139 can include various amount of user information 141 set to better identify what level of access the managing user 139 can have. However, the new user 139 may not have any user information 141 set at all. Using the relationship between the new user 139 and the managing user 139, an agent 127 can infer that the new user 139 would not be able to access any resources 133 that the managing user 139 would not be able to access. Additionally, the managing user 139 can also have other subordinate users 139. Using the relationships of the managing user 139, an agent 127 can determine that the new user 139 may need to be similarly situated to the other subordinate users 139 with regards to what resources 133 the new user 139 can access. Similarly, an agent 127 may be able to infer various user roles 119 related to positions in the company based on relations 140 to other users 139 within the company. For instance, subordinates of a specific c-suite executive may imply a user's role 119 within the company, such as

The user 139 can include user information 141, which can represent various types of identifying information about the user. For example, the user information 141 can include which department of the company the user 139 is assigned, the specific job title of the user 139, the projects which the user 139 has been assigned, the location of the user 139, personally identifying information about the user 139, and various other types of information. The user information 141 can also include credentials to connect to various APIs 160. For example, a user 139 can have credentials in the user information 141 to connect to a social media API 160 (e.g., Facebook®, etc.). Using the API credentials, the authentication service 121 or the agent 127 can access additional information about the user 139 to come to a more informed judgement about the user's roles 119 or access to specific resources 133.

The agent configuration data 142 can represent various types of information used to configure a base foundation model 124 to become an agent 127. The agent configuration data 142 can include, for example, agent instructions 144, API action information 145, RBAC information 148, an agent prompt 151, and potentially other data. For instance, the agent configuration data 142 can also include a name for the agent 127, a selection of the base foundation model 124, any agent instructions 144 that detail a persona, tasks, goals, and transactions that the agent 127 can participate in, and various other types of information. In at least some embodiments, the agent configuration data 142 (in whole or in part) can be exported and/or imported to the data store 115 to be used to train the one or more agents 127.

The agent information 144 can include various types of information that can be used to provide guidance, instruction, or identity to an agent 127. For instance, agent information 144 can include an agent name and a persona prompt. A personal prompt can be used to provide context to the agent 127 when providing any response. The agent information 144 can also include configuration for specific prompts. A specific prompt can include various types of information about clients, contextual information, placeholder spots for conversation histories 136, placeholder spots for API responses, and various other information. Specific prompts can be used for and differentiated by any time the authentication service 121 interacts with the agent 127. For example, there could be a specific prompt for when a user provides input, there could be a specific prompt for when an API 160 provides an API response, there could be a specific prompt for when resources 133 are to be sent to an agent 127, there could be a specific prompt for requesting a specific type of response from the agent 127, or various other points in which the authentication service 121 and the agent 127 interact.

The API action information 145 can represent a subset of the agent configuration data 142 that pertains to how the agent 127 can interact with external APIs, such as an API 160 on the API environment 109. The API action information 145 can include an action name, an API endpoint (e.g., network address, etc.), a specified function/method to call on the API, an API schema, instructions for when the agent 127 should invoke this action, and how to format the response from the API to the agent 127.

The RBAC information 148 can represent a subset of the agent configuration data 142 that pertains to how the agent 127 or authentication service 121 can interact with an RBAC service 118. The RBAC information 148 can include an RBAC endpoint (e.g., within a data store 115, a uniform resource locator (URL), a network address, etc.), the name of the RBAC service 118 (if applicable), the type of information that is contained within the RBAC service 118, and various other information.

The agent prompt 151 can represent at least a portion of a prompt used to configure a base foundation model 124 to an agent 127. The agent prompt 151 can be a prompt that can assist an agent 127 perform a certain prompt strategy. In some embodiments, the agent prompt 151 can be a chain of thought prompt, which provides context to an agent 127 to better make a logical flow of decisions. In some embodiments, the agent prompt 151 can be a plan and solve prompt, such that the agent prompt 151 can better assist the agent 127 select and implement specified algorithms, adjust parameters, and refine the agent 127 to optimize performance. In some embodiments, the agent prompt 151 can be a tree of thought prompt, such that the agent prompt 151 provides a hierarchy of concepts that branch into more specified concepts, thus allowing the agent 127 to breakdown complex topics according to the tree structure. Other prompt strategies can also be used to configure and fine-tune a base foundation model 124 to become an agent 127. In various embodiments, the agent prompt 151 can be text that is provided to a base foundation model 124. In some embodiments, the information can be compiled into a directive for the base foundation model 124 to ingest to become more specialized in its tasks.

The client device 106 is representative of a plurality of client devices that can be coupled to the network 112. The client device 106 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client device 106 can include a display 154. The display 154 can include, for example, one or more devices such as liquid crystal display (LCD) displays, gas plasma-based flat panel displays, organic light emitting diode (OLED) displays, electrophoretic ink (E-ink) displays, LCD projectors, or other types of display devices, etc.

The client device 106 can be configured to execute various applications such as a client application 157 and/or other applications. The client application 157 can be executed in a client device 106, for example, to access network content served up by the computing environment 103 and/or other servers, thereby rendering a user interface on the display 154. To this end, the client application 157 can include, for example, a browser, a dedicated application, etc., and the user interface can include a network page, an application screen, etc. The client device 106 can be configured to execute applications beyond the client application 157 such as, for example, email applications, social networking applications, word processors, spreadsheets, and/or other applications.

The API environment 109 can include, for example, a server computer or any other system providing computing capability. Alternatively, the API environment 109 can employ a plurality of computing devices that can be arranged, for example, in one or more server banks or computer banks or other arrangements. Such computing devices can be located in a single installation or can be distributed among many different geographical locations. For example, the API environment 109 can include a plurality of computing devices that together can include a hosted computing resource, a grid computing resource and/or any other distributed computing arrangement. In some cases, the API environment 109 can correspond to an elastic computing resource where the allotted capacity of processing, network, storage, or other computing-related resources can vary over time.

Various applications and/or other functionality can be executed in the API environment 109 according to various embodiments. The components executed on the API environment 109, for example, can include an API 160, and other applications, services, processes, systems, engines, or functionality not discussed in detail herein.

An API 160 is a set of rules and protocols that allow different software applications to communicate and interact with each other. An API 160 can define methods and data formats that the applications can use to request and exchange information. APIs 160 can enable developers to access specific functionalities or data from a service, library, or platform, fostering interoperability between different software systems. The API 160 can be executed to perform one or more actions 163 (generically as “an action 163”). In some embodiments, an API 160 can be viewed as a collection of one or more independent actions 163 that can be invoked to perform some needed functionality. In some embodiments, an action 163 can only be invoked if one or more parameters are passed to the action 163. In various embodiments, an API schema can detail available actions 163 on the API 160, along with any necessary and optional parameters. The API schema could be formatted in accordance with a specified API format, such as the OpenAPI Schema JSON format, API Blueprint, or RESTful API modeling language (RAML) format. The API schema could also be represented as a Web Services Description Language (WSDL) format, other XML-based formats, or any format to convey the information about the functionality and parameters of the API.

In at least some embodiments, the API 160 can act as an external RBAC service, meaning the API 160 can provide information similar to that one would expect from the RBAC service 118. For instance, the API 160 can provide one or more user roles 119 identified for an external service. An external service could be a social media platform (e.g., Facebook®, Twitter® or X™, Instagram®, etc.) that provides information about users, such as their relations to other users and various other information about the users.

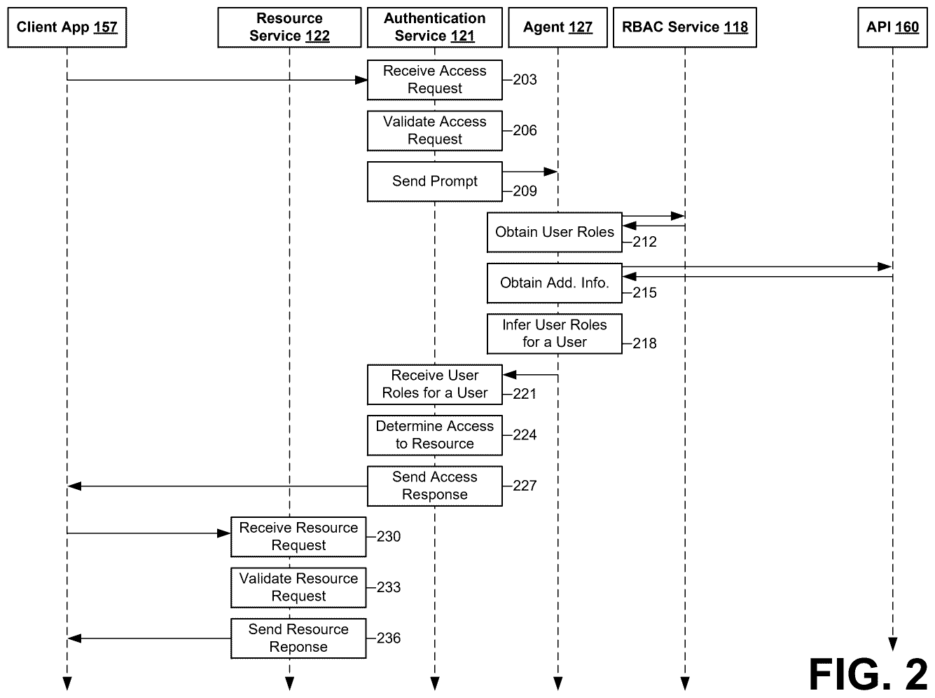

Moving on to FIG. 2, shown is a sequence diagram that provides at least one example of the interactions between the client application 157 of the client device 106; the resource service 122, the authentication service 121, the agent 127, and the RBAC service 118 of the computing environment 103; and the API 160 of the API environment 109. The sequence diagram of FIG. 2 can provide merely an example of the many different types of functional arrangements that can be employed by the client application 157 of the client device 106; the resource service 122, the authentication service 121, the agent 127, and the RBAC service 118 of the computing environment 103; and the API 160 of the API environment 109. As an alternative, the sequence diagram of FIG. 2 can be viewed as depicting examples of elements of one or more method implemented within the network environment 100.

Beginning with block 203, the authentication service 121 can receive an access request from a client application 157. In various embodiments, the authentication service 121 can receive an access request for the capability to access a resource 133 from a client device 106 associated with a user 139. In such embodiments, the access request can include a user identifier for the user 139, a resource identifier for the resource 133, and/or various other information, such as user information 141.

In at least some embodiments, the authentication service 121 can receive an access request that includes a JWT token. A JWT token is a data structure that defines a compact and self-contained way for securely transmitting information between parties as a JSON object that can be verified and trusted because it is digitally signed. A JWT token comprises at least three portions, the header, the payload, and the signature. The header typically includes the type of token, which is “JWT,” and the signing algorithm being used. The payload contains the information about the entity (e.g., user 139, etc.) and/or additional data. In various embodiments, the payload can contain an identifier for a specific resource 133 to be accessed, identification for the user 139, and/or any other information. The signature can be cryptographically generated to verify that the header and payload have not been modified.

Next, at block 206, the authentication service 121 can validate the access request from the client application 157. In various embodiments, the authentication service 121 can validate the access request in response to receiving the access request. For some embodiments, validating the access request can be ensuring that a user 139 can be identified from the access request. In some embodiments, validating the access request can also include ensuring that a specific resource 133 has been specified within the access request. In various embodiments, the access request can include a JWT token. The authentication service 121 can validate the structure and signatures of the JWT token to ensure that the payload of the JWT has not been modified.

Continuing to block 209, the authentication service 121 can send a prompt to the agent 127. In various embodiments, the authentication service 121 can generate and send a prompt to identify at least one user role for the user to an agent of a machine learning model. The prompt can direct the agent 127 to determine which user roles 119 should be attributed to a specified user 139. The prompt can include various types of information, including a user identifier for the user 139, user relations 140, user information 141, a conversation history 136, any agent configuration data 142, received user roles 119, or various other type of information. In various embodiments, the prompt can include the user identifier and user role information. The user role information can include an endpoint for an RBAC service 118 or an external RBAC service accessible via an API 160 for which the agent 127 can obtain the user roles 119. Such an RBAC service 118 or external RBAC service accessible via an API 160 can include one or more user roles 119. Each user role 119 of the one or more user roles 119 can be associated in the RBAC service 118 or external RBAC service accessible via an API 160 with a description of the user role 119.

Next, at block 212, the agent 127 can obtain user roles 119 from the RBAC Service 118. In various embodiments, the agent 127 can send a user role request to the RBAC service 118. In some embodiments, the agent 127 can send the user role request to the RBAC service 118 in response to receiving the prompt from the authentication service 121. The RBAC service 118 can then analyze the user role request and send back one or more user roles 119. Accordingly, the agent 127 can receive the one or more user roles 119 from the RBAC service 118. In at least some embodiments, the RBAC service 118 can be accessed by sending the user access request to an endpoint for the RBAC service 118 sent along with the user role information of the prompt. In at least some embodiments, the RBAC service 118 can be accessed by using the RBAC information 148 of the agent configuration data 142.

A user role 119 can define a set of permissions that are logically grouped together based on the responsibilities of the users 139 within an organization. For instance, a software developer might have access to a large number of resources related to software code, image assets, technical information, non-confidential information, and other non-critical resources; a human resource (HR) manager, by contrast might have access to image assets, non-confidential information, confidential information, and other non-critical resources; and a member of the C-Suite (e.g., Chief Executive Officer, Chief Operating Officer, Chief Medical Officer, Chief Financial Officer, etc.), by further contrast, may have full access to all the resources available at an organization. The roles of software developer, HR manager, and C-Suite personnel could be individual roles related to a person's job. Other roles may also exist to identify what physical spaces (e.g., buildings, offices, rooms, etc.) a person may access. For instance, a user 139 may be assigned a role that allows them access to the sixteenth floor of the Atlanta office, whereas another user 139 may be assigned a role to allow them access to the entirety of the New York office. Various other types of user roles 119 can also exist. Permissions, for which user roles 119 control, can include various types of values. For example, at least some permissions defined by the user role 119 can be permissions to read, write, execute, and/or delete particular files or folders. At least another permission defined by the user role 119 could be a Boolean value representing allowed or denied accessibility to the resource. The user roles 119 can also include a description of what types of users 139 meet the criteria to qualify for the user role 119.

Continuing to block 215, the agent 127 can obtain additional information from the API 160. In various embodiments, the agent 127 can send an API request to an API 160 for the API data or additional information associated with the user 139. In at least some embodiments, the agent 127 can send the API request to the API 160 in response to receiving the prompt from the authentication service 121. The API 160 can then analyze the API request and send back API data or additional information related to the user 139, which the agent 127 can receive. In at least some embodiments, the API 160 can be accessed by sending the API request to an endpoint for the API 160 that was sent along with the user role information of the prompt. In at least some embodiments, the API 160 can be accessed by using the API action information 145 of the agent configuration data 142.

In at least some embodiments, the agent 127 could obtain information from a directory service using a directory service API 160. A directory service can include any service that maps names of network resources to their respective network addresses. The directory service could be implemented using an object-oriented database or data store. Examples of directory services include Microsoft® Active Directory®, Red Hat® “389 Directory Server” (previously referred to as the Fedora® Directory Server), Oracle® Internet Directory (OID), Apple® Open Directory, and OpenLDAP, among others. The types of user information that could be obtained can include user information (e.g., name, job title(s), phone number, address, email address, social media usernames, authorization credentials, etc.), related user information (e.g., client/agent relationships, manager/employee relationships, organizational structure, etc.), group information (e.g., which persons participated in projects, relationships identifying a vocation or skills of a person, relationships identifying that person in a specified region, etc.), and/or other types of information. In at least some embodiments, the agent 127 can seek information (e.g., user information, related users, other information, etc.) from a social media platform or other website (e.g., Facebook®, Twitter® or X™, Instagram®, etc.), which can be used to make better inferences about whether a person is permitted to access the resource. If the agent 127 can receive this information (e.g., user information, related users, other information, etc.) from various sources (e.g., a directory service, a social media platform or other website, etc.), the agent 127 can make more informed decisions about the relationships between users and better determine whether a specified user can access the resource.

Next, at block 218, the agent 127 can determine user roles 119 for a user 139. The agent 127 understands context. Using the information provided by the prompt received from the authentication service 121, information related to the user 139, such as user relations 140 and user information 141, the one or more user roles 119 received from the RBAC service 118 including descriptions of the user roles 119, and/or any additional information received from the API 160, the agent 127 can determine user roles 119 for a specified user 139. The user roles 119 can be extrapolated by the agent 127 to provide user 139 unique permissions that would otherwise be impossible to manage by a single access control individual.

In at least some embodiments, the agent 127 can analyze user information 141, such as a department of the company for which the user 139 is assigned, the specific job title of the user 139, the projects which the user 139 has been assigned, the location of the user 139, personally identifying information about the user 139, and various other types of information. In at least some embodiments, the agent 127 can analyze user relations 140, such as who the user 139 reports to and/or who reports to the user 139. Further, the agent 127 can utilize user information 141 related to related users 140 to better infer specific user roles 119 of the user 139 in question. Further, the agent 127 can process each of the descriptions for the user role 119 to determine based on all the previous information provided about the user 139 applies to the user role 119. In doing so, the agent 127 can dynamically attribute user roles 119 to users 139, thus removing the need to manually assign specific user roles 119 to users 139. Because the agent 127 is a specialized machine learning model, the agent 127 can recognize patterns in the data to best identify which user roles 119 fit the information provided about the user 139. The agent 127 can consider the inputted words, syntax, and context to generate relevant and coherent output user roles 119 for a user 139.

Continuing to block 221, the authentication service 121 can receive user roles 119 for the user 139 from the agent 127. Once the agent 127 has determined or otherwise inferred one or more user roles 119 for the user 139, the agent 127 can send the determined user roles 119 to the authentication service 121, which the authentication service 121 can receive.

Next, at block 224, the authentication service 121 can determine access to the resource 133. Using the determined user roles 119 for the user 139, the authentication service can determine whether the user 139 can access the resource 133 by comparing the determined user roles 119 for the user 139 to allowable user roles 119 for the resource 133. Each resource 139 will have allowable user roles 119 set for each of the resources 139 and each of the user roles 119 will define permissions for what actions can be performed. Permissions, for which user roles 119 control, can include various types of values. For example, at least some permissions defined by the user role 119 can be permissions to read, write, execute, and/or delete particular files or folders. At least another permission defined by the user role 119 could be a Boolean value representing allowed or denied accessibility to the resource. Based on the permissions, the authentication service 121 can either grant or deny access to the resource 133. In at least some embodiments, the authentication service 121 can grant the user access to the resource by authorizing a portion of the JWT based on the at least one user role. In at least some embodiments, the authentication service 121 can send an authentication response, as further described in block 227.

Continuing to block 227, the authentication service 121 can send an access response to the client application 157. In at least some embodiments, the authentication service 121 can send an access response to the client application 157 where the access response indicates whether the access has been granted or denied to the resource 133. In at least some embodiments, the access response will indicate that the resource 133 is inaccessible to the specified user due to the determined user roles 119 for the user 139. In some embodiments, the access response can indicate that the resource 133 is accessible to the user 139. In at least some embodiments, the authentication service 121 can send the JWT token as part of the access response. By sending the JWT token, the client device 106 can then send the JWT token to the resource service 122 to attempt to obtain the resource 133 itself. If the JWT token indicates that the user 139 has access to the resource 133, then the resource service 122 can serve the resource 133 to the client device 106. Otherwise, the resource service 122 can reject the JWT token.

Next, at block 230, the resource service 122 can receive a resource request to obtain a resource 133. In various embodiments, the resource service 122 can receive the resource request to obtain a resource 133 from the client application 157. The resource request can include an indication from the authentication service 121 that the user is permitted to access the resource 133. For instance, the authentication service 121 can provide the client application 157 with a unique password, key, or token that can be used to verify that the user 139 is authorized to access the resource 133. In at least some embodiments, the resource service 121 can receive a resource request that includes a JWT token that can be used to verify that a user 139 has access to a specified resource 133.

Continuing to block 233, the resource service 122 can validate the resource request. In various embodiments, the resource service 122 can validate the resource request in response to receive the resource request. For some embodiments, validating the resource request can be ensuring that a specified resource 133 exists and determining whether the resource request includes a key, password, and/or token that can be used to verify that the user 139 is authorized to access the resource 133. In some embodiments, the resource request can include a JWT token that can be used to verify that the user 139 has access to a specified resource 133. The resource service 122 can validate the JWT token using cryptographic validation algorithms to ensure the payload of the JWT token has not been modified and then verify the claims within the payload of the JWT token. In at least some embodiments, the resource service 122 can determine that the resource request should not be fulfilled because the user 139 fails to be assigned to a required user role 119 or any of the permissible user roles 119.

Next, at block 236, the resource service 122 can send a resource response to the client application 157. In various embodiments, the resource service 122 can send the resource response that includes the resource 133. In at least some embodiments, the resource response can omit the resource 133 when the user 139 does not have the requisite user roles 119 to access the resource 133. Once block 236 has completed, the sequence diagram of FIG. 2 can come to an end.

For illustration purposes, the following is a description of at least one practical example of the interactions between the client application 157 of the client device 106; the resource service 122, the authentication service 121, the agent 127, and the RBAC service 118 of the computing environment 103; and the API 160 of the API environment 109, as described by FIG. 2. However, it is understood that other interactions between the various components of the present disclosure are also possible. Accordingly, other examples are also encompassed by the various embodiments of the present disclosure.

In this example, John Doe, acting as an access manager, can direct at least one of the RBAC service 118 or the agent 127 to “grant all direct reports access to John Doe's business credit card so that the direct reports can make business purchases. Each direct report cannot spend more than $200 per month using John Doe's business credit card.” At block 203, a person or a card authorizer on behalf of a person can send a request to the authentication service 121 to make a purchase with the business credit card. At block 206, the authentication service 121 can validate the access request.

At block 209, the authentication service 121 can send a prompt to the agent 127. For example, a prompt could state:

### - - - - BEGIN PROMPT - - - -

You are a security agent whose job is to protect the identified resource from unauthorized access. To determine whether an access is unauthorized, perform the following tasks:
1) Access information from an RBAC service identified at the following address—[Endpoint Address: example 192.168.0.1].
2) Obtain user role information from the accessed RBAC service, including at least [list of user role information] for the following user [enter user identifier].
3) Access each of the APIs to obtain information about the user. The APIs can include Facebook®, X®, and LinkedIn®. The APIs can also include an Active Directory® accessible at the following address-[Endpoint Address: example 192.168.0.1], [Endpoint Address: example 192.168.0.2], [Endpoint Address: example 192.168.0.3].
4) determine one or more user roles 119 for a user. In determining the user roles for a user, consider the information from the RBAC service and the API information.

Additionally, you can consider that at least one of the requested resources has an access requirement stating, “grant all direct reports access to John Doe's business credit card so that the direct reports can make business purchases. Each direct report cannot spend more than $200 per month using John Doe's business credit card.”

### - - - - END PROMPT - - - -

Although this is an example of a prompt, various prompts could include more or less information based on the specific needs of the system.

Based on the prompt, the agent 127 can access the RBAC service 118 (as described in block 212), one or more of the APIs 160 (as described in block 215) and determine user roles 119 for the user 139 (as described in block 218), which the agent 127 can send to the authentication service 121. In performing the determination step at block 218, the agent 127 can extrapolate information about the users 139 that would not otherwise be available to a traditional authorization system. For example, the agent 127 can extrapolate relationships that do not exist in the RBAC service 118 by using the API information. Additionally, traditional authorization systems would not be able to determine whether a direct report has spent more than some threshold amount, such as $200 in this example. Examples of the user roles 119 in this example can be “Has Not Exceeded the Payment Threshold,” “User is a direct report of John Doe,” and/or various other user roles 119. In some embodiments, the user roles 119 could simply indicate that a user 139 has access to the resource.

Continuing to block 224, the authentication service 121 can determine whether the specified user 139 can access the requested resource 133, in this case, make a purchase using John Doe's business credit card. The authentication service 121 can send its response to the client application 157, which can be used to authorize a transaction at block 230 by sending the response from the authentication service 121 to the resource service 122. If the resource service 122 validates that the user can make the purchase, then the resource service 122 will authorize the transaction. The resource service 122 can then send a confirmation that the transaction has been authorized, thus ending the example of FIG. 2.

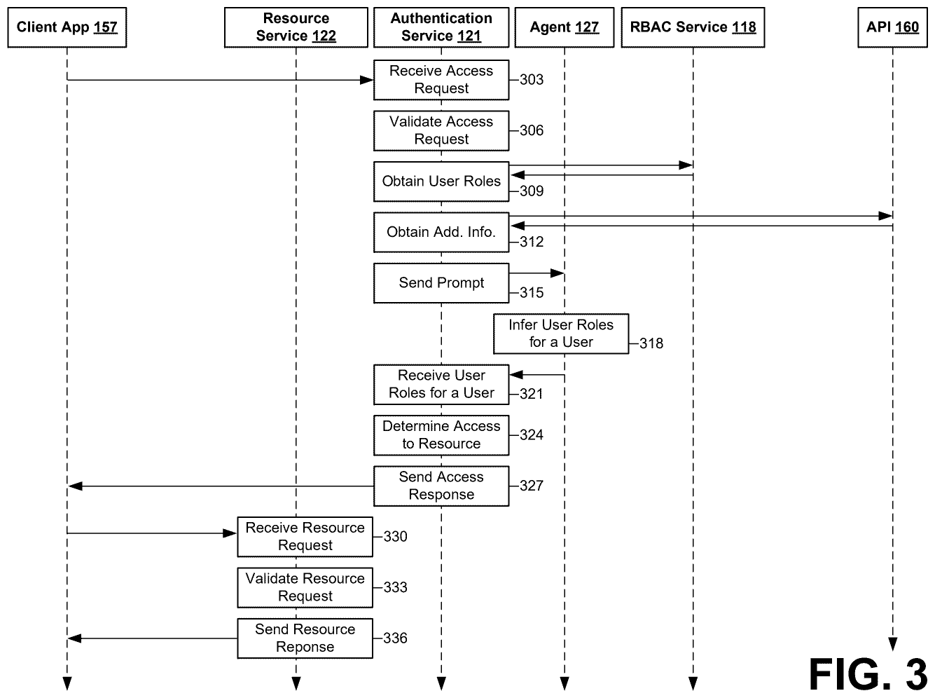

Moving on to FIG. 3, shown is a sequence diagram that provides at least one example of the interactions between the client application 157 of the client device 106; the resource service 122, the authentication service 121, the agent 127, and the RBAC service 118 of the computing environment 103; and the API 160 of the API environment 109. The sequence diagram of FIG. 3 can provide merely an example of the many different types of functional arrangements that can be employed by the client application 157 of the client device 106; the resource service 122, the authentication service 121, the agent 127, and the RBAC service 118 of the computing environment 103; and the API 160 of the API environment 109. As an alternative, the sequence diagram of FIG. 3 can be viewed as depicting examples of elements of one or more method implemented within the network environment 100.

Beginning at block 303 of FIG. 3, the authentication service 121 can receive an access request from a client application 157, as previously described in block 203 of FIG. 2. Next, at block 306, the authentication service 121 can validate the access request from the client application 157, as previously described in block 206 of FIG. 2.

Next, at block 309, the authentication service 121 can obtain user roles 119 from the RBAC Service 118. In various embodiments, the authentication service 121 can send a user role request to the RBAC service 118. In some embodiments, the authentication service 121 can send the user role request to the RBAC service 118 in response to receiving the prompt from the authentication service 121. The RBAC service 118 can then analyze the user role request and send back one or more user roles 119. Accordingly, the authentication service 121 can receive the one or more user roles 119 from the RBAC service 118. In at least some embodiments, the RBAC service 118 can be accessed by sending the user access request to an endpoint for the RBAC service 118 sent along with the user role information of the prompt. In at least some embodiments, the RBAC service 118 can be accessed by using the RBAC information 148 of the agent configuration data 142.

A user role 119 can define a set of permissions that are logically grouped together based on the responsibilities of the users 139 within an organization. For instance, a software developer might have access to a large number of resources related to software code, image assets, technical information, non-confidential information, and other non-critical resources; a human resource (HR) manager, by contrast might have access to image assets, non-confidential information, confidential information, and other non-critical resources; and a member of the C-Suite (e.g., Chief Executive Officer, Chief Operating Officer, Chief Medical Officer, Chief Financial Officer, etc.), by further contrast, may have full access to all the resources available at an organization. The roles of software developer, HR manager, and C-Suite personnel could be individual roles related to a person's job. Other roles may also exist to identify what physical spaces (e.g., buildings, offices, rooms, etc.) a person may access. For instance, a user 139 may be assigned a role that allows them access to the sixteenth floor of the Atlanta office, whereas another user 139 may be assigned a role to allow them access to the entirety of the New York office. Various other types of user roles 119 can also exist. Permissions, for which user roles 119 control, can include various types of values. For example, at least some permissions defined by the user role 119 can be permissions to read, write, execute, and/or delete particular files or folders. At least another permission defined by the user role 119 could be a Boolean value representing allowed or denied accessibility to the resource. The user roles 119 can also include a description of what types of users 139 meet the criteria to qualify for the user role 119.

Continuing to block 312, the authentication service 121 can obtain additional information from the API 160. In various embodiments, the authentication service 121 can send an API request to an API 160 for the API data or additional information associated with the user 139. In at least some embodiments, the authentication service 121 can send the API request to the API 160 in response to receiving the prompt from the authentication service 121. The API 160 can then analyze the API request and send back API data or additional information related to the user 139, which the authentication service 121 can receive. In at least some embodiments, the API 160 can be accessed by sending the API request to an endpoint for the API 160 that was sent along with the user role information of the prompt. In at least some embodiments, the API 160 can be accessed by using the API action information 145 of the agent configuration data 142.

In at least some embodiments, the authentication service 121 could obtain information from a directory service using a directory service API 160. A directory service can include any service that maps names of network resources to their respective network addresses. The directory service could be implemented using an object-oriented database or data store. Examples of directory services include Microsoft® Active Directory®, Red Hat® “389 Directory Server” (previously referred to as the Fedora® Directory Server), Oracle® Internet Directory (OID), Apple® Open Directory, and OpenLDAP, among others. The types of user information that could be obtained can include user information (e.g., name, job title(s), phone number, address, email address, social media usernames, authorization credentials, etc.), related user information (e.g., client/agent relationships, manager/employee relationships, organizational structure, etc.), group information (e.g., which persons participated in projects, relationships identifying a vocation or skills of a person, relationships identifying that person in a specified region, etc.), and/or other types of information. In at least some embodiments, the authentication service 121 can seek information (e.g., user information, related users, other information, etc.) from a social media platform or other website (e.g., Facebook®, Twitter® or X™, Instagram®, etc.), which can be used to make better inferences about whether a person is permitted to access the resource. Because the authentication service 121 can receive this information (e.g., user information, related users, other information, etc.) from various sources (e.g., a directory service, a social media platform or other website, etc.) and provide the information to the agent 127, the agent 127 can make more informed decisions about the relationships between users and better determine whether a specified user can access the resource.

Next, at block 315, the authentication service 121 can send a prompt to the agent 127. In various embodiments, the authentication service 121 can generate and send a prompt to identify at least one user role for the user to an agent of a machine learning model. The prompt can direct the agent 127 to determine which user roles 119 should be attributed to a specified user 139. The prompt can include various types of information, including a user identifier for the user 139, user relations 140, user information 141, a conversation history 136, any agent configuration data 142, received user roles 119, or various other type of information. In various embodiments, the prompt can include the user identifier and user role information. In various embodiments, the prompt can include the user roles 119 received from the RBAC service 118 at block 309. In various embodiments, the prompt can also include the additional information from the API 160 received at block 312.

Next, at block 318, the agent 127 can determine user roles 119 for a user 139, as previously described in block 218 of FIG. 2. Next, at block 321, the authentication service 121 can receive user roles 119 for the user 139 from the agent 127, as previously described in block 221 of FIG. 2. Next, at block 324, the authentication service 121 can determine access to the resource 133, as previously described in block 224 of FIG. 2. Next, at block 327, the authentication service 121 can send an access response to the client application 157, as previously described in block 227 of FIG. 2.

Next, at block 330, the resource service 122 can receive a resource request to obtain a resource 133, as previously described in block 230 of FIG. 2. Next, at block 333, the resource service 122 can validate the resource request, as previously described in block 233 of FIG. 2. Next, at block 336, the resource service 122 can send a resource response to the client application 157, as previously described in block 236 of FIG. 2. Subsequently, the sequence diagram of FIG. 3 can come to an end.

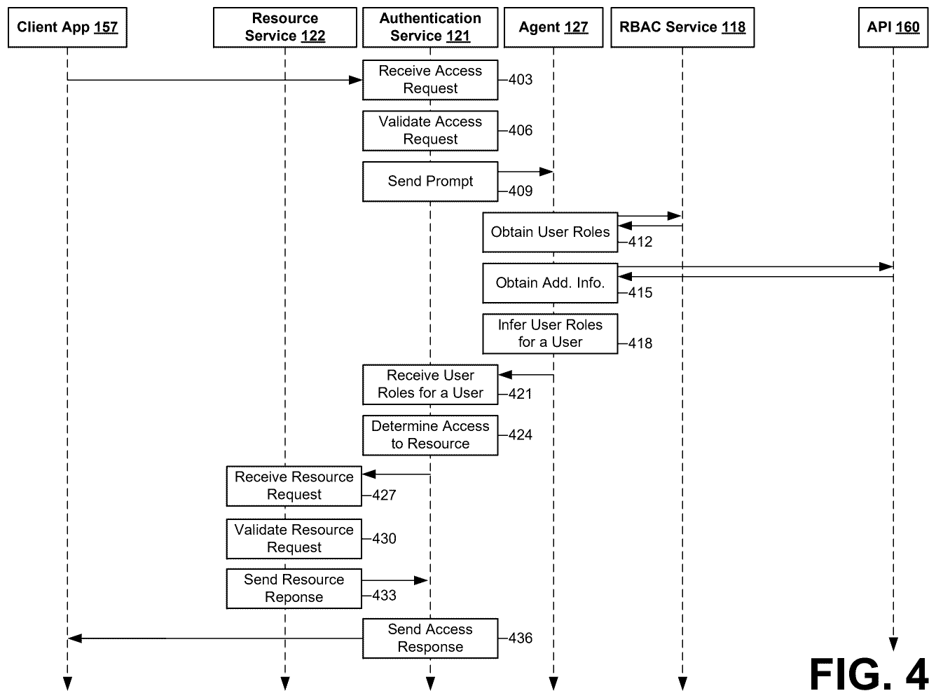

Moving on to FIG. 4, shown is a sequence diagram that provides at least one example of the interactions between the client application 157 of the client device 106; the resource service 122, the authentication service 121, the agent 127, and the RBAC service 118 of the computing environment 103; and the API 160 of the API environment 109. The sequence diagram of FIG. 4 can provide merely an example of the many different types of functional arrangements that can be employed by the client application 157 of the client device 106; the resource service 122, the authentication service 121, the agent 127, and the RBAC service 118 of the computing environment 103; and the API 160 of the API environment 109. As an alternative, the sequence diagram of FIG. 4 can be viewed as depicting examples of elements of one or more method implemented within the network environment 100.

Beginning at block 403 of FIG. 4, the authentication service 121 can receive an access request from a client application 157, as previously described in block 203 of FIG. 2. Next, at block 406, the authentication service 121 can validate the access request from the client application 157, as previously described in block 206 of FIG. 2. Next, at block 409, the authentication service 121 can send a prompt to the agent 127, as previously described in block 209 of FIG. 2. Next, at block 412, the agent 127 can obtain user roles 119 from the RBAC Service 118, as previously described in block 212 of FIG. 2. Next, at block 415, the agent 127 can obtain additional information from the API 160, as previously described in block 215 of FIG. 2. Next, at block 418, the agent 127 can determine user roles 119 for a user 139, as previously described in block 218 of FIG. 2. Next, at block 421, the authentication service 121 can receive user roles 119 for the user 139 from the agent 127, as previously described in block 221 of FIG. 2. Next, at block 424, the authentication service 121 can determine access to the resource 133, as previously described in block 224 of FIG. 2.

Next, at block 427, the resource service 122 can receive a resource request to obtain a resource 133 from the authentication service 121. In various embodiments, the resource service 122 can receive the resource request to obtain a resource 133 from the authentication service 121. In such an embodiment, the authentication service can be a conduit of both authorizing the access to and providing the resource 133 to the client application 157. The resource request can include an indication from the authentication service 121 that the user is permitted to access the resource 133. The resource request can include a unique password, key, or token that can be used to verify that the user 139 is authorized to access the resource 133. In at least some embodiments, the resource service 121 can receive a resource request that includes a JWT token that can be used to verify that a user 139 has access to a specified resource 133.

Continuing to block 430, the resource service 122 can validate the resource request. In various embodiments, the resource service 122 can validate the resource request in response to receive the resource request. For some embodiments, validating the resource request can be ensuring that a specified resource 133 exists and determining whether the resource request includes a key, password, and/or token that can be used to verify that the user 139 is authorized to access the resource 133. In some embodiments, the resource request can include a JWT token that can be used to verify that the user 139 has access to a specified resource 133. The resource service 122 can validate the JWT token using cryptographic validation algorithms to ensure the payload of the JWT token has not been modified and then verify the claims within the payload of the JWT token. In at least some embodiments, the resource service 122 can determine that the resource request should not be fulfilled because the user 139 fails to be assigned to a required user role 119 or any of the permissible user roles 119.

Next, at block 433, the resource service 122 can send a resource response to the client application 157. In various embodiments, the resource service 122 can send the resource response that includes the resource 133 to the authentication service 121. In at least some embodiments, the resource response can omit the resource 133 when the user 139 does not have the requisite user roles 119 to access the resource 133. In at least some embodiments, the resource service 122 can store at least a portion of the resource 133 in the memory of the computing device so that the authentication service 121 can easily access the resource 133 to deliver to the client application 157.

Continuing to block 436, the authentication service 121 can send an access response to the client application 157. In at least some embodiments, the authentication service 121 can send an access response to the client application 157 where the access response indicates whether the access has been granted or denied to the resource 133. In various embodiments, if the access has been granted, the access response can include the resource 133 itself, or a link for the client application 157 to obtain the resource 133. In at least some embodiments, the access response will indicate that the resource 133 is inaccessible to the specified user due to the determined user roles 119 for the user 139. Once block 439 has completed, the sequence diagram of FIG. 4 can come to an end.

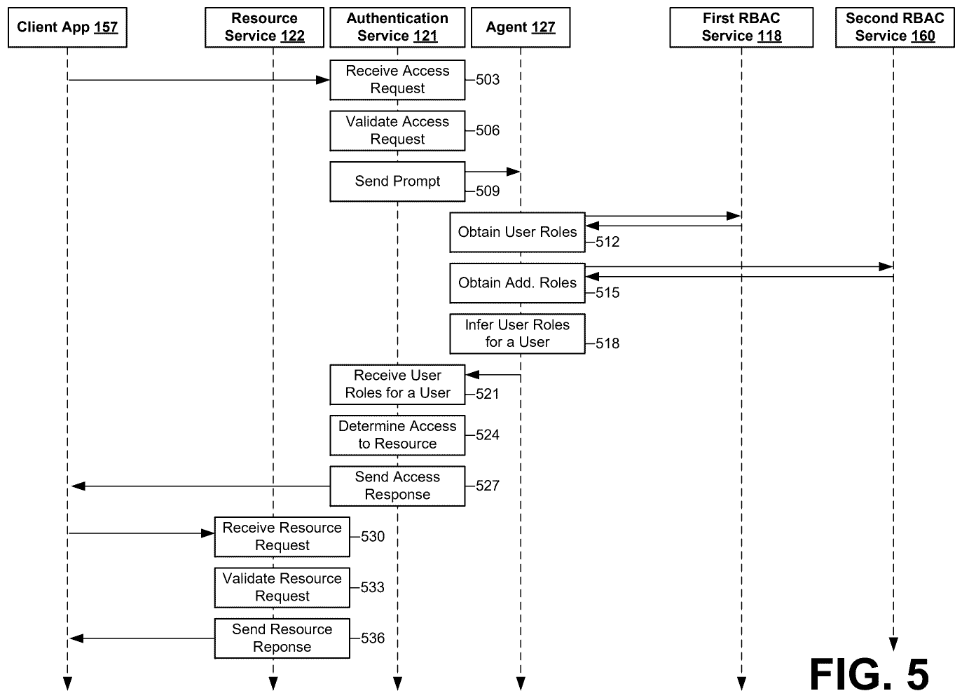

Moving on to FIG. 5, shown is a sequence diagram that provides at least one example of the interactions between the client application 157 of the client device 106; the resource service 122, the authentication service 121, the agent 127, and the first RBAC service 118 of the computing environment 103; and the second RBAC service 118 of the API environment 109. The sequence diagram of FIG. 2 can provide merely an example of the many different types of functional arrangements that can be employed by the client application 157 of the client device 106; the resource service 122, the authentication service 121, the agent 127, and the RBAC service 118 of the computing environment 103; and the API 160 of the API environment 109. As an alternative, the sequence diagram of FIG. 2 can be viewed as depicting examples of elements of one or more method implemented within the network environment 100.

Beginning at block 503 of FIG. 5, the authentication service 121 can receive an access request from a client application 157, as previously described in block 203 of FIG. 2. Next, at block 506, the authentication service 121 can validate the access request from the client application 157, as previously described in block 206 of FIG. 2. Next, at block 509, the authentication service 121 can send a prompt to the agent 127, as previously described in block 209 of FIG. 2. Next, at block 512, the agent 127 can obtain user roles 119 from the RBAC Service 118, as previously described in block 212 of FIG. 2.

Continuing to block 215, the agent 127 can obtain additional user roles from the second RBAC Service 118. In at least some embodiments, the API 160 can act as an external RBAC service, meaning the API 160 can provide information similar to that one would expect from the RBAC service 118. For instance, the API 160 can provide one or more user roles 119 identified for an external service. An external service could be a social media platform (e.g., Facebook®, Twitter® or X™ Instagram®, etc.) that provides information about users, such as their relations to other users and various other information about the users. In some embodiments, the user role information can further include a second endpoint representing a second RBAC service for which the agent can obtain at least a second user role 119 corresponding to the user 139 where the second endpoint corresponds to an external service. In various embodiments, the agent 127 can send a second user role request to the second RBAC service. In response, the agent 127 can receive at least the second user role from the second RBAC service. This information received from the second RBAC service can be used just like any other additional information from an API 160 as previously discussed in block 218 of FIG. 2.

Next, at block 518, the agent 127 can determine user roles 119 for a user 139, as previously described in block 218 of FIG. 2. Next, at block 521, the authentication service 121 can receive user roles 119 for the user 139 from the agent 127, as previously described in block 221 of FIG. 2. Next, at block 524, the authentication service 121 can determine access to the resource 133, as previously described in block 224 of FIG. 2. Next, at block 527, the authentication service 121 can send an access response to the client application 157, as previously described in block 227 of FIG. 2.

Next, at block 530, the resource service 122 can receive a resource request to obtain a resource 133, as previously described in block 230 of FIG. 2. Next, at block 533, the resource service 122 can validate the resource request, as previously described in block 233 of FIG. 2. Next, at block 536, the resource service 122 can send a resource response to the client application 157, as previously described in block 236 of FIG. 2. Subsequently, the sequence diagram of FIG. 5 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well-known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive, from a client device associated with a user, an access request for a capability to access a resource, the access request comprising a user identifier for the user and a resource identifier for the resource;
send, to an agent of a machine learning model, a prompt to identify at least one user role for the user, the prompt comprising the user identifier and user role information;
receive, from the agent, the at least one user role for the user;
determine the capability for the user to access the resource by at least comparing the at least one user role for the user to allowed user roles for the resource; and
send, to the client device, an access response, the access response indicating the capability for the user to access the resource.

2. The system of claim 1, wherein the prompt further comprises a plurality of user roles and the machine-readable instructions further cause the computing device to at least:
send, to a role-based access control (RBAC) service, a user role request; and
receive, from the RBAC service, a user role response comprising a plurality of user roles.

3. The system of claim 1, wherein the user role information includes at least an endpoint for a role-based access control (RBAC) service that has a plurality of user roles, the plurality of the user roles comprises the at least one user role, and each user role of the plurality of user roles being associated in the RBAC with a description of the user role.

4. The system of claim 1, wherein the access response indicates that the resource is inaccessible to the user.

5. The system of claim 1, wherein the access response indicates that the resource is accessible to the user and comprises the at least one user role for the user.

6. The system of claim 5, wherein the machine-readable instructions further cause the computing device to at least send, in response to determining the capability for the user to access the resource, the resource to the client device associated with the user.

7. The system of claim 1, wherein the resource is at least partially stored in the memory of the computing device.

8. A method, comprising:
receiving, by an authentication service and from a client device associated with a user, an access request for a capability to access a resource, the access request comprising a user identifier for the user and a resource identifier for the resource;
sending, by the authentication service and to an agent of a machine learning model, a prompt to identify at least one user role for the user, the prompt comprising the user identifier and user role information;
receiving, by the authentication service and from the agent, the at least one user role for the user; and
determining, by the authentication service, the capability for the user to access the resource by at least comparing the at least one user role for the user to allowed user roles for the resource.

9. The method of claim 8, wherein the access request includes a JSON web token (JWT), and the method further comprising:
validating, by the authentication service and in response to receiving the access request, the JWT;
granting, by the authentication service and in response to determining that the user is capable of accessing the resource, the user access to the resource by authorizing a portion of the JWT based on the at least one user role; and
sending, by the authentication service and to the client device, an access response comprising the JWT.

10. The method of claim 9, further comprising:
receiving, by a resource service and from the client device, a resource request to obtain the resource, the resource request comprising the JWT;
validating, by the resource service, that the JWT is granted access to the resource; and
sending, by the resource service and to the client device, a resource response comprising the resource.

11. The method of claim 8, wherein the user role information comprises a first endpoint representing a first role-based access control (RBAC) service for which the agent can obtain the at least one user role, and the method further comprising:
sending, by the agent of the machine learning model and to the first role-based access control (RBAC) service, a user role request; and
receive, by the agent of the machine learning model and from the first RBAC service, the at least one user role.

12. The method of claim 11, wherein the user role information further comprises a second endpoint representing a second RBAC service for which the agent can obtain at least a second user role corresponding to the user, the second endpoint corresponding to an external service.

13. The method of claim 12, further comprising:
sending, by the agent of the machine learning model and to the second RBAC service, a second user role request; and
receive, by the agent of the machine learning model and from the second RBAC service, at least the second user role.

14. The method of claim 8, wherein the prompt further comprises API data associated with the user, the authentication service receives the at least one user role for the user in response to sending the API data associated with the user to the agent of the machine learning model, and the method further comprising:
sending, by the authentication service and to an external Application Programming Interface (API), an API request for the API data associated with the user; and
receive, by the authentication service and from the external API, an API response comprising the API data associated with the user.

15. A non-transitory, computer-readable medium, comprising machine-readable instructions that, when executed by a processor of a computing device, cause the computing device to at least:
receive, from a client device associated with a user, an access request for a capability to access a resource, the access request comprising a user identifier for the user and a resource identifier for the resource;
send, to an agent of a machine learning model, a prompt to identify at least one user role for the user, the prompt comprising the user identifier and user role information;
receive, from the agent of the machine learning model, the at least one user role for the user;
determine the capability for the user to access the resource by at least comparing the at least one user role for the user to allowed user roles for the resource; and
send, to the client device, an access response, the access response indicating the capability for the user to access the resource.

16. The non-transitory, computer-readable medium of claim 15, wherein the prompt further comprises a plurality of user roles and the machine-readable instructions further cause the computing device to at least:
send, to a role-based access control (RBAC) service, a user role request; and
receive, from the RBAC service, a user role response comprising a plurality of user roles.

17. The non-transitory, computer-readable medium of claim 15, wherein the user role information includes at least an endpoint for a role-based access control (RBAC) service that has a plurality of user roles, the plurality of the user roles comprises the at least one user role, and each user role of the plurality of user roles being associated in the RBAC with a description of the user role.

18. The non-transitory, computer-readable medium of claim 15, wherein the access response indicates that the resource is inaccessible to the user.

19. The non-transitory, computer-readable medium of claim 15, wherein the access response indicates that the resource is accessible to the user and comprises the at least one user role for the user.

20. The non-transitory, computer-readable medium of claim 19, wherein the machine-readable instructions further cause the computing device to at least send, in response to determining the capability for the user to access the resource, the resource to the client device associated with the user.
